(19) United States
(12) Patent Application Publication
(10) Pub. No.: US 2005/0186815 A1
(43) Pub. Date: Aug. 25, 2005

(54) AC grounding structure for electronics enclosure

(75) Inventors: Vijay L. Asrani, Boynton Beach, FL (US); Paul Morningstar, N. Lauderdale, FL (US); Patrick L. Fariello, Boynton Beach, FL (US)

Correspondence Address: FLEIT, KAIN, GIBBONS, GUTMAN, BONGINI;& BIANCO P.L., 551 N.W. 77TH STREET, SUITE 111, BOCA RATON, FL, 33487, US

(73) Assignee: MOTOROLA, INC., SCHAUMBURG, IL (US)

(21) Appl. No.: 10/784,021

(22) Filed: Feb. 20, 2004

(51) Int. Cl. H01R 12/00

(52) U.S. Cl. 439/108

(57) ABSTRACT

An electronic device enclosure grounding structure (200) that provides a low impedance path to ground for selected AC frequencies. A conductive portion of an electronic enclosure, such as a conductive back (108) of a cell phone (100) has a capacitive coupling to a second surface (206) that is conductively isolated from the enclosure. Second surface (206) is connected to a ground point (207) through a conductive arm (205) that has a predefined inductance. The resulting series capacitance-inductance circuit (300) allows a reactive connection between the enclosure (108) and ground (207) that has a settable resonant frequency.

### FIELD OF THE INVENTION

The present invention generally relates to the field of electronic enclosure grounding and more particularly to grounding enclosures for radio frequency devices.

### BACKGROUND OF THE INVENTION

Portable wireless electronic devices, such as cellular telephones, strive to minimize the size of the device, including the size of external antennas used by the device. Such portable wireless electronic devices also benefit from structural and cosmetic enhancements that result from having a metal case, including a metallic back that is typically used to cover the device's battery. This metal back cover, however, acts as an RF shield and can also trap RF energy inside a wireless device enclosure which would otherwise radiate from the ground plane of the device's Printed Circuit (PC) board in the absence of a conductive back cover and by reciprocity to the ground plane of the PC board. A cover is able to serve many purposes for a device, including that of a removable battery cover.

Many wireless devices, such as cellular telephones, pagers, remote control devices, and the like, are required to operate in multiple RF bands. Examples of wireless devices that are required to operate in multiple RF bands include cellular phones that are able to communicate in RF bands near 800 MHz, 900 MHz, 1800 MHz and 1900 MHz. Furthermore, in order to satisfy the minimal size requirement for portable wireless devices, designers are typically restricted to using only one antenna for these multiple RF bands.

The use of a single antenna to transmit and/or receive over such a wide bandwidth requires the use of frequency selective impedance matching networks. The use of a metallic/conductive casing and/or cover with a portable wireless device further complicates the impedance matching complexity over the wide bandwidths required by some devices. This complexity still does not address the reduced efficiency of a wireless device that is operating with a metallic/conductive casing and/or cover.

Therefore a need exists to develop wireless device design that radiates efficiently in the presence of metallic/conductive casing and/or cover.

### SUMMARY OF THE INVENTION

According to a preferred embodiment of the present invention, an AC grounding structure has a ground point and a first conductive surface. The first conductive surface is conductively isolated from the ground point. The AC grounding structure further has a second conductive surface that is conductively coupled to the ground point and physically separated from the first conductive surface. The second conductive surface is positioned so as to capacitively couple to the first surface with a pre-determined capacitance.

In another aspect of the present invention, a wireless device has at least one of a receiver for wirelessly receiving transmitted signals and a transmitter for wirelessly transmitting signals. The wireless device also has a baseband processing portion that is communicatively coupled to the at least one receiver and transmitter and that processes at least one of data, voice, image and video signals in order to interface with at least one of the receiver and the transmitter. The wireless device also has an RF grounding structure. The RF grounding structure has a ground point and a first conductive surface that is conductively isolated from the ground point. The RF grounding structure also has a second conductive surface that is conductively coupled to the ground point and physically separated from the first conductive surface. The second conductive surface is positioned so as to capacitively couple to the first surface with a pre-determined capacitance.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a view of a cellular phone according to an exemplary embodiment of the present invention.

FIG. 2 illustrates an exemplary RF grounding structure according to an embodiment of the present invention.

FIG. 3 illustrates an RF equivalent circuit for the exemplary grounding structure illustrated in FIG. 2.

FIG. 4 illustrates a clip installation within a wireless device of an exemplary embodiment of the present invention.

FIG. 5 illustrates a schematic diagram for a cellular phone according to an exemplary embodiment of the present invention.

FIG. 6 illustrates a dual coupling surface grounding structure according to an exemplary embodiment of the present invention.

FIG. 7 illustrates a reactively coupled single top surface grounding structure according to a further alternative embodiment of the present invention.

FIG. 8 illustrates a reactively coupled dual top surface grounding structure according to another further alternative embodiment of the present invention.

### DETAILED DESCRIPTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language).

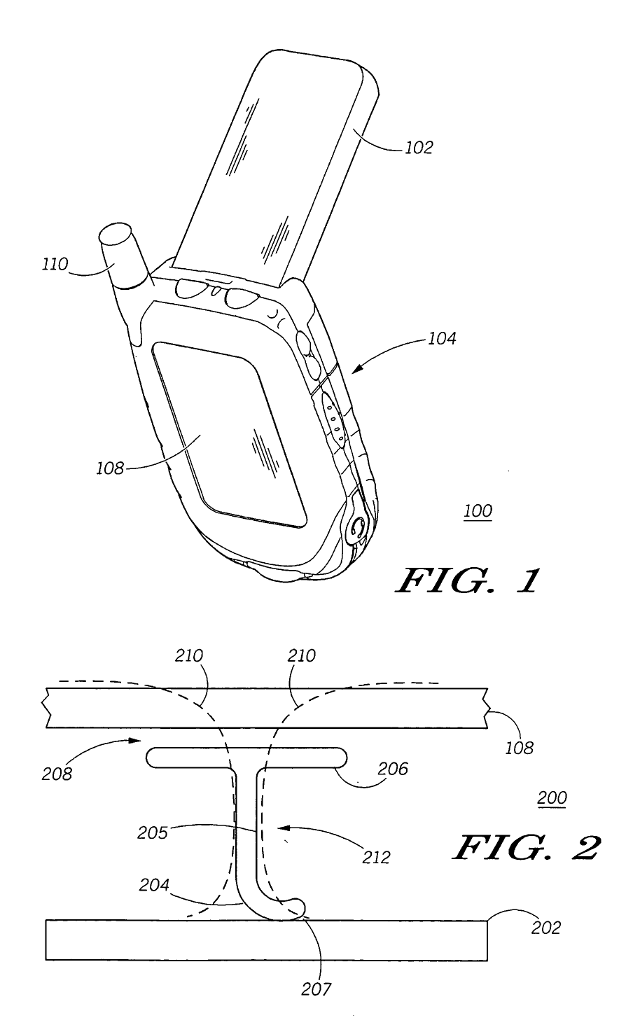

FIG. 1 illustrates a view of a cellular phone 100 according to an exemplary embodiment of the present invention. Cellular phone 100 is representative of the wide range of wireless devices that are able to incorporate embodiments of the present invention. Cellular phone 100 is a well-known “flip-phone” design that includes a flip top 102 and a base portion 104. Base portion 104 of this exemplary cellular phone 100 has an enclosure that includes portions of conductive material, includes a conductive back 108. Back 108 is a metallic part that can be used to cover a battery and electronic circuitry that is internal to the base portion 104. It should be understood by a person skilled in the art that the functions of the flip 102 and the base 104 can be interchanged. Base portion 104 further includes an antenna 110 that is used to transmit and/or receive RF signals used to communicate data and other information, such as sound, voice and/or images, to and from the cellular phone 100. Electronic circuitry is internally contained within the base portion 104 on at least one circuit board that is substantially parallel to the conductive back 108. The at least one circuit board includes an RF drive point for the antenna 110 that is in proximity to the antenna 110. The at least one circuit board further contains at least one ground point that is near the RF drive point to allow connection for at least one RF grounding structure, as is described herein.

The shape of the at least one circuit board and its layout, any battery and a battery door/device back characteristics significantly influence electromagnetic propagation from the cellular phone 100. For example, modeling has shown that lower frequency signals propagate with an orientation parallel to the longer dimension of an enclosure or circuit board ground plane and higher frequency signals propagate with an orientation parallel to the shorter dimension of a circuit board ground plane. With a conductive battery door/device back, however, these signals are somewhat shielded and do not propagate as efficiently from the cellular phone 100. This is a particular problem for enclosures or cases that have a dimension that approaches one half of the wavelength for an RF frequency used by the cellular phone.

FIG. 2 illustrates an exemplary RF grounding structure 200 according to an embodiment of the present invention. This exemplary RF grounding structure 200 is located within the cellular phone 100, within the base portion 104 and at a point near antenna 110 and RF generation circuits. The exemplary RF ground structure 200 operates to reactively couple the conductive back 108 to a ground point on a circuit board within the cellular phone. This reactive coupling provides a frequency selective coupling between the conductive back 108 and the ground point on the internal circuit board and allows tailoring of the frequency ranges over which the conductive back 108 presents a ground plane effect.

The exemplary grounding structure 200 includes a circuit board 202 that includes a ground plane portion. A ground plane portion internal to the wireless device is not a requirement for the operation of embodiments in the present invention, but is usually included in RF circuit designs for various reasons. The circuit board 202 includes a ground point 207. Ground point 207 is a conductive contact area on the top surface of circuit board 202 and is in conductive contact with the ground plane portion of circuit board 202 in this example. Ground point 207 is a point of physical contact for components of the exemplary grounding structure. In this exemplary embodiment, ground point 207 is located in substantial proximity to the antenna feed point within the cellular phone 100. Further embodiments of the present invention are able to include grounding points that are located anywhere within or even near the cellular phone 100.

The exemplary grounding structure 200 includes the conductive back 108 of cell phone 100. Back 108 is formed from a conductive material, such as aluminum and can be coated with non-conductive materials. The conductive back 108 in this example is a first conductive surface that is conductively isolated from the RF ground plane portion, and ground point 207, on the circuit board 207. The exemplary embodiments of the present invention, which do not use a conductive or other physical contact between ground and the enclosure surface, advantageously allow construction of part or all of an enclosure for an electronic device to use anodized aluminum or other painted or treated metals. These metals can be used without etching or otherwise modifying that material to support a physical connection between a ground connection and a conductive portion of the enclosure material.

The exemplary grounding structure 200 includes a clip 212 that is formed from a yieldable, conductive spring metal. Clip 212 includes a top surface 206 that is a second conductive surface in this embodiment. Top surface 206 is placed in proximity to but is conductively isolated from back 108. Top surface 206 in the exemplary embodiment is separated from back 108 by a gap 208. The surface area of top surface 206 and the dimension of the gap 208 are chosen to create parallel plate capacitor that allows reactive coupling between the conductive back 108 and the top surface 206 with a pre-determined capacitance.

The exemplary grounding structure 200 includes a conductive arm 205 that has a first end that engages, i.e., is attached to in this embodiment, the top surface 206. Conductive arm 206 of the exemplary embodiment is designed to have dimensions, especially its width and length, that result in the conductive arm having a per-defined inductance. In operation, this pre-defined inductance of the conductive arm 205 is in series with the pre-defined capacitance created by the conductive back 108 and top surface 206. This creates a series inductor-capacitor circuit with a pre-defined reactance at selected frequencies.

The clip 212 has a yieldable contact 204 that contacts the ground point 207 on the circuit board 202. The yieldable contact 204 also engages, i.e., is attached to in this embodiment, a second end of the conductive arm 205, which is the end that is opposite the first end of the conductive arm 205 that engages the top surface 206. Yieldable contact 204 forms a conductive contact between the ground point 207 and the clip 212 so that all portions of clip 212 are in conductive contact with the ground point 207 and the ground plane portion of circuit board 202 in this example.

The conductive and reactive properties of the exemplary grounding structure 200 allow electrical energy at selected RF frequencies to efficiently flow between the ground plane structure of circuit board 202 and conductive back 108. This flow of electrical energy is illustrated as energy flow 210, which is shown to include RF surface currents that flow along portions of the clip 212, electric field energy that couples across the capacitive gap 208 formed by top surface 206 and conductive back 108, and the RF surface currents that flow along the surfaces of conductive back 208.

FIG. 3 illustrates an RF equivalent circuit 300 for the exemplary grounding structure 200. The RF equivalent circuit 300 illustrates that the ground plane portion of the circuit board 202 is coupled through ground point 207 to the conductive back 108 through a series capacitor-inductor circuit. Capacitor 302 is formed, as discussed above, by the parallel surfaces of the conductive back 108 and the top surface 206. The inductor 304 is formed by the inductive characteristics of clip 212, particularly the conductive arm 205. Selection of values for the inductor 304 and capacitor 302 allow a frequency selective coupling of the conductive back 108 to the ground point 207. Values of capacitor 302 and inductor 304 are selected and/or changed by varying the dimensions of clip 212 components, such as the surface area of top surface 206 and/or the length, and/or width of the conductive arm 205. The gap 208 can also be varied to affect the capacitance of capacitor 302. Preferred embodiments of the present invention design RF grounding structures such that capacitor 302 and inductor 304 form a series resonant circuit near an RF frequency of interest. RF frequencies of interest include a frequency band in which a wireless device incorporating the RF grounding structure operates. Some multiple band wireless devices have been observed to optimally operate by using a RF grounding structure that resonates at higher frequency bands and that does not resonate at lower frequency bands in which the device operates.

As is known to ordinary practitioners in the relevant arts, the capacitance of capacitor 302, which is a parallel plate capacitor formed by the top surface 206 and conductive back 108, is readily calculated. It is assumed that the area of the conductive back 108 is greater than the area of the top surface 206. The capacitance of this parallel place capacitor, in picofarads, is given by:
C(pF)=(0.225*∈ᵣ*A)/D
Where:
   A is the area of the top surface 206
   D is the distance of gap 208
   ∈ᵣ is the dielectric constant of the gap 208

The gap 208 can have an ∈ᵣ that is not equal to one (i.e., equivalent to that of air), and can be a composite effective dielectric constant produced by non metallic materials filling the gap 208 and/or by no metallic materials coating the metal surface of 108 and 206.

Given this capacitance and the inductance (L) of inductor 304, we can determine the resonant frequency of the RF ground coupling structure 200. For a desired series resonant frequency, which is equal to 2πω, and with a given inductance (L) of inductor 304, the desired value for capacitor 302 is given by
C=1/(ω²*L).

It will be appreciated by ordinary persons skilled in the relevant arts that the resistance of conductors within the exemplary embodiments is not equal to zero. It will also be appreciated by persons of ordinary skill in the relevant arts that the dielectric materials may not be lossless. Ordinary practitioners in the relevant arts are able to assess the effects of the electrical resistance for components of the coupling structure and determine effective designs that incorporate those finite resistance values.

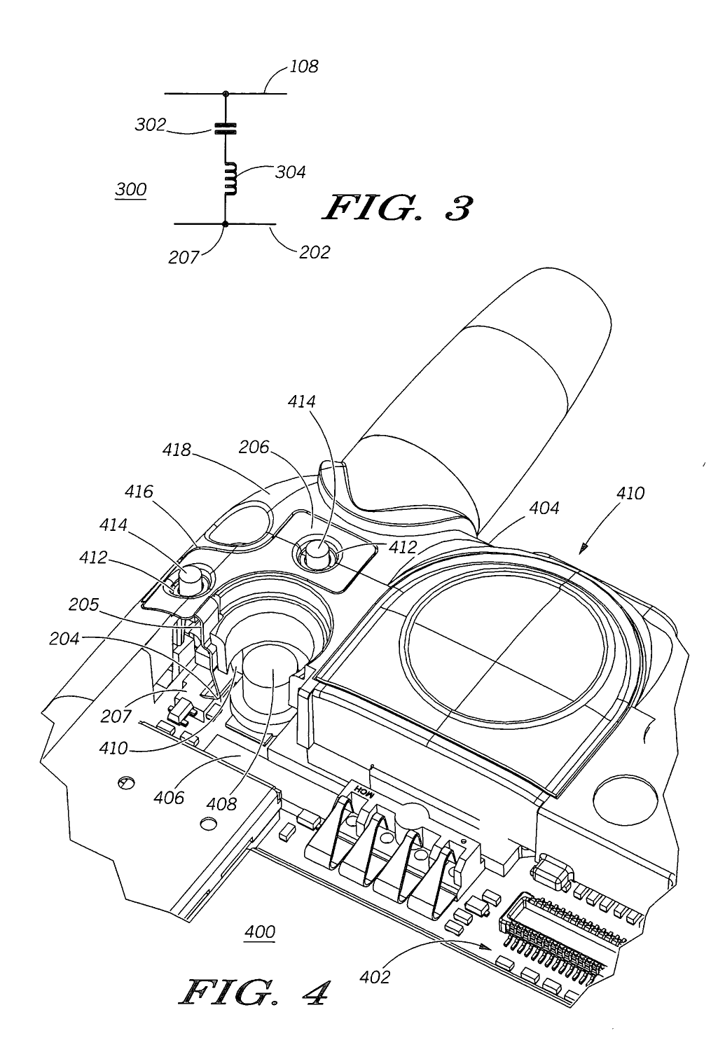

FIG. 4 illustrates a clip installation 400 within a wireless device 450 of an exemplary embodiment of the present invention. This exemplary wireless device 450 includes a circuit board 406 that includes RF circuits 402 that include RF receivers and RF transmitters. RF circuits 402 are coupled to an RF drive point 408, which has a coaxial connector in this example. This exemplary circuit board 406 also has its RF drive output collocated with this RF antenna drive point 408. The exemplary circuit board 406 further has an alternate RF path (not shown) used to couple the RF circuits 402 to an RF antenna 110 used by the wireless device. In this example, the ground point 207 is located in substantial proximity to the RF drive point in this embodiment. For this invention to operate, the ground point 207 can also be located anywhere in the wireless device.

The wireless device 450 has a substantially non-conductive plastic case 404 that serves several purposes, including the mounting of the circuit board 406. Clip 212 in this example is formed so as to be fastened to the plastic case 404. The plastic case 404 has a bottom recess 410 that allows yieldable contact 204 to yieldable engage ground point 207 on circuit board 406 without mechanical interference from the plastic case 404. Further embodiments of the present invention are able to include physical features on the clip 212 to physically engage plastic case 404 so as to retain the clip 212 to the plastic case 404. An example of such a physical feature are protrusions on the clip 212 that extend into bottom recess 410 so as to engage the plastic case 404 at that point.

Plastic case 404 has a top ridge 418. Conductive back 108, which is not shown in this figure, is normally positioned so as to be in mechanical contact and to rest on top of the top ridge 418. Top surface 206 of clip 212 is located within a top recess 416 that is located on the top ridge 418. The size of the top recess 416 is designed so as accept the top surface 206 of clip 212. The depth of the top recess 416 is designed so as to hold the top surface 206 and maintain the desired gap 208 between the top surface 206 of the clip 212 and the conductive back 108 when the conductive back 108 is placed onto the plastic case 404. Top surface 206 of clip 212 of this exemplary embodiment can include numerous holes 412 (such as the two shown in this figure) that accept plastic pins 414 when the top surface 206 of clip 212 is placed into the top recess 416. Plastic pins 414 are part of plastic case 404 and are deformed, such as being heat staked and thereby melted or otherwise deformed, so as to more completely fill holes 412 and create a retaining cap over the area of the top surface 206 in proximity to holes 412 so as to retain clip 212 in position on the plastic case 404. Other methods are able to be used to secure the clip 212 in a desired position, including the use of adhesives and other techniques.

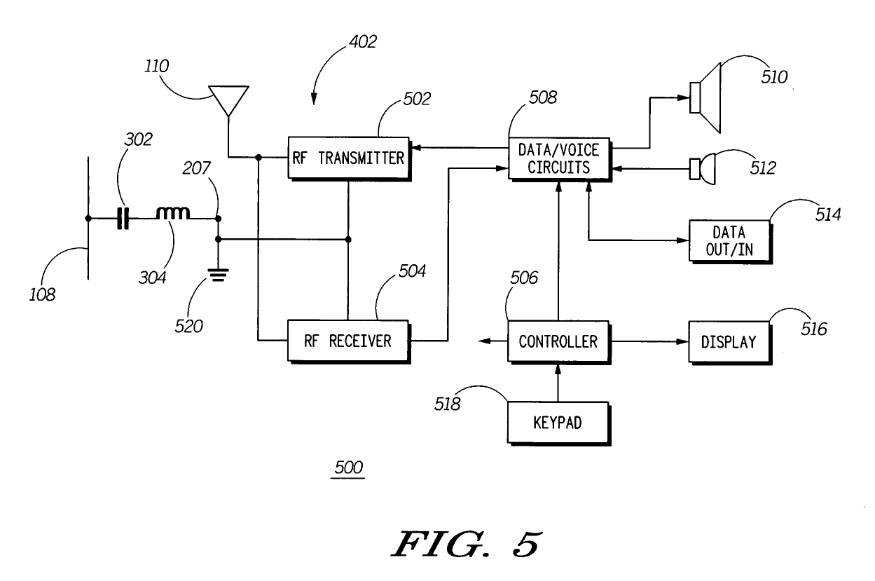

FIG. 5 illustrates a schematic diagram 500 for a cellular phone according to an exemplary embodiment of the present invention. The cellular phone schematic diagram 500 includes an antenna 110 that is coupled to an RF transmitter 502 and an RF receiver 504. The RF transmitter 502 and RF receiver 504 form the RF circuits 402 in this example. The cellular phone schematic diagram 500 further includes data/voice circuits 508. The data/voice circuits 508 accept voice input from microphone 512, provide audio signals to speaker 510 and exchange input and output data with data out/in port 514. The RF transmitter 502 accepts signals from the data/voice circuits 508 and the RF receiver provides signals to the data/voice circuits 508. A controller 506 controls the operation of the cellular phone, and provides data to a display 516 for output. Controller 506 accepts operator input from keypad 518.

The schematic diagram 500 further shows that the RF transmitter 502 and the RF receiver 504 are connected to ground 520. The conductive back 108 is also connected, through capacitor 302 and inductor 304, to the ground point 207 as is discussed herein. Ground points for the RF transmitter 502 and the RF receiver 504 are also connected to ground 520. In the exemplary embodiment, ground point 207 is physically located near the ground connection for the RF receiver 504 and the RF transmitter 502.

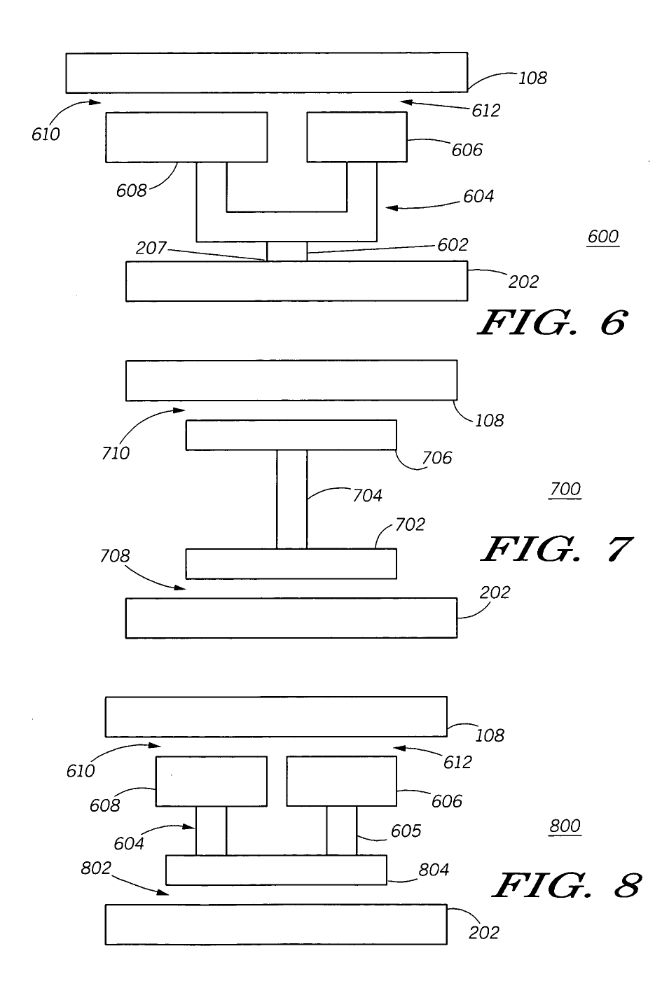

FIG. 6 illustrates a dual coupling surface grounding structure 600 according to an exemplary embodiment of the present invention. The previously discussed embodiment included an RF grounding structure that included a single surface that forms a capacitive coupling to a conductive back. The dual coupling surface grounding structure 600 of this alternative embodiment uses a yieldable contact 602 to make a contact with a ground point 207 on the ground plane 202 of a circuit board. The dual coupling surface grounding structure 600 has two top surfaces, top surface A 606 and an additional conductive surface top surface B 608. These two top surfaces are conductively connected to the yieldable contact 602 via a two arm inductive link 604. The two arm inductive link 604 of this alternative embodiment has two conductive arms that form respective independent conductive paths or coupling elements between the yieldable contact, and therefore the ground point 207, and each of the two top surfaces. The respective predetermined reactance, particularly the inductance, of each of the respective coupling elements, or arms, of the two arm inductive link 604 is able to be altered to achieve a desired reactive or resonant property for the combination of the inductance of that arm and the capacitive coupling to the conductive back 108. Top surface A 606 capacitively couples to the conductive back 108 through a first gap 612. Similarly, top surface B 608 couples through a second gap 610 to the conductive back 108. The surface area of each of these top surfaces and/or the height of the first gap 612 and second gap 610, are able to be varied in order to vary the capacitance of the coupling between the respective surface and the conductive back 108.

Further embodiments of the present invention include more than two conductive surfaces that couple to the conductive back 108. These multiple surfaces are able to have the same or differing surface areas and differing separations from the conductive back 108 so as to create different capacitance values. Embodiments that include more than one top surface are able to locate the multiple top surfaces close together or distribute them to locations at various points near the conductive back 108. These multiple top surfaces are further able to connect to a common ground point of the electronic circuits of a device or at different ground points within the device incorporating the grounding structure. These multiple surfaces are able to provide different capacitance values for coupling to the conductive back and/or are able to have different inductance values for paths connecting these top surfaces to ground so that different resonant frequencies or other reactive characteristics are realized. This allows a conductive back, or other enclosure components in further embodiments, to have an effective connection to ground at a number of RF frequencies. Yet further embodiments have additional ground points. Embodiments with additional ground points couple one or more of the additional conductive surfaces to one or more of these additional ground points. Embodiments with additional ground points allow multiple clips, such as clip 212, to be placed at different locations within an electronic device. Such disperse placement of clips allows a grounding structure design that is able to incorporate propagation and other characteristics of the device's enclosure to allow a more effective grounding scheme at desired RF frequencies.

FIG. 7 illustrates a reactively coupled single top surface grounding structure 700 according to a further alternative embodiment of the present invention. The reactively coupled single top surface grounding structure is similar to the exemplary RF grounding structure 200 with the replacement of the yieldable contact 204 with an capacitive ground plane coupling surface 702. This further alternative embodiment has a single top surface 706 that couples to the conductive back 108 through a gap 710. The single top surface 706 further has a conductive arm 704 to connect the single top surface 706 to the capacitive ground plane coupling surface 702. The capacitive ground plane coupling surface 702 capacitively couples to the ground plane 202 of the electronic device through a ground plane gap 708. The surface area of the capacitive ground plane coupling surface 702 and the height of the ground plane gap 708 are able to be adjusted to select a capacitance value for this structure. The reactance of the capacitor formed by the capacitive ground plane coupling surface 702 and the ground plane 202 at one or more RF frequencies of interest can be adjusted to operate with the reactance of the conductive arm 704 and reactance of the capacitor formed by the single top surface 706 and conductive back 108 to form an RF circuit with a desired composite resonance at RF frequencies of interest, including a resonance at an RF frequency of interest.

FIG. 8 illustrates a reactively coupled dual top surface grounding structure 800 according to another further alternative embodiment of the present invention. The reactively coupled dual top surface grounding structure 800 includes a capacitive ground plane coupling surface 804 that capacitively couples to the ground plane 202 through ground plane gap 802. The reactively coupled dual top surface grounding structure 800 also has two top surfaces, top surface A 606 and top surface B 608, that capacitively couple to the conductive back through a first gap 612 and second gap 610. Each of the two top surfaces are conductively connected to the capacitive ground plane coupling surface 802 by a conductive arm, first conductive arm 605 and second conductive arm 604, respectively. The reactance of the first conductive arm 605 and the second conductive arm 604 can be adjusted, as described above, to realize a desired inductance and reactance at one or more RF frequencies of interest.

The reactively coupled grounding structures, such as the reactively coupled single top surface grounding structure 700 and the reactively coupled dual top surface grounding structure 800 of the exemplary alternative embodiments, advantageously allow effective coupling of a conductive enclosure of a device to ground at one or more RF frequencies of interest, while obviating a need to have a conductive connection between either a ground plane within the device and the conductive enclosure material.

Embodiments of the present invention advantageously allow part or all of an electronic enclosure, such as case backs, entire cases and/or entire enclosures, to be constructed of conductive materials that do not require a physical connection to ground. Materials such as anodized aluminum, painted or otherwise treated metals, and other materials, can be used as an enclosure and no spot treatments such as etching or other effects are required to provide a connection to ground at RF or other AC frequencies of interest. The exemplary embodiments further allow manufacturing of metal components that are mounted on plastic frames without requiring contact between different metal parts. Connecting conductive enclosure material to ground generally requires soldering or forming contacts that have to be formed to relatively tight tolerances. Achieving these tolerances in metal formations adds to the manufacturing complexity for a product. The manufacturing of the exemplary embodiment limits manufacturing tolerances to the plastic case 404, since no mechanical, metal-to-metal contact is required to the conductive back 108. Obviating metal-to-metal contact, especially if dissimilar metals are to be used, reduces corrosion problems. Furthermore, metal-to-metal contacts that allow removal of an enclosure component, such as the conductive back 108, generally use a spring contact or other mechanism that repeatedly makes and breaks contact with the conductive back 108, thereby allowing dirt, corrosion, and other effects to introduce a contact resistance between ground and the enclosure, thereby degrading the performance of the ground connection and possibly the operation of the device itself.

The above described RF grounding structure connects a second surface that is capacitively coupled to the conductive back 108. Further embodiments of the present invention utilize more complex connections between the ground point and that second surface so as to realize alternative impedances between the conductive back 108 and ground and to more specifically tailor the impedance values for the coupling of the conductive back 108 to ground for various RF frequencies of interest.

It is further obvious in light of the teachings of this invention that embodiments of the present invention are applicable to any application requiring a frequency selective coupling of a surface to ground. Such surfaces include, without limitation, cases for portable computing devices (including laptops and personal digital assistants), wireless devices of all types, electronic devices that benefit from frequency selective shielding, and other such applications.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

1. An electrical grounding structure for an electronic device enclosure, the electrical grounding structure comprising:
a ground point;
a ground point coupling element coupled to the ground point;
a first conductive surface of a device enclosure, conductively isolated from the ground point; and
a second conductive surface, conductively coupled to the ground point coupling element and physically separated from the first conductive surface, positioned so as to capacitively couple to the first surface with a pre-determined capacitance within an RF band of interest.

2. The electrical grounding structure according to claim 1, further comprising an electronic device containing the ground point, the first conductive surface and the second conductive surface, the electronic device being one of a wireless device and a portable computing device.

3. The electrical grounding structure according to claim 1, the ground point located in substantial proximity to at least one of an antenna RF drive point and an RF amplifier output.

4. The electrical grounding structure according to claim 1, the ground point coupling element being reactively coupled to and conductively isolated from the ground point.

5. The electrical grounding structure according to claim 1, further comprising at least one additional conductive surface, each of the at least one additional conductive surface conductively isolated from the first conductive surface and positioned so as to capacitively couple to the first surface with a respective pre-determined capacitance, and each of the at least one additional conductive surface being coupled to the ground point.

6. The electrical grounding structure according to claim 5, wherein each of the at least one additional conductive surface is coupled to the ground point through a respective coupling element that has a respective pre-determined impedance.

7. The electrical grounding structure according to claim 1, further comprising:
at least one additional ground point; and
at least one additional conductive surface, each of the at least one additional conductive surface conductively isolated from the first conductive surface and positioned so as to capacitively couple to the first surface with a respective pre-determined capacitance, and each of the at least one additional conductive surface being coupled to at least one of the ground point and at least one of the at least one additional ground point.

8. The electrical grounding structure according to claim 1, the second conductive ground point coupling element being conductively coupled to the ground point.

9. The electrical grounding structure according to claim 8, wherein the ground point coupling element comprises a yieldable contact, conductively connected to the second conductive surface, that yieldably engages the ground point.

10. The electrical grounding structure according to claim 1, further comprising a conductive element that forms at least part of a conductive path conductively coupling the second conductive surface to the ground point coupling element, the conductive element having an inductance that operates in conjunction with the pre-determined capacitance to exhibit a pre-defined impedance between the ground point and the first conductive surface near at least one RF frequency.

11. The electrical grounding structure according to claim 10, further comprising a yieldable contact that yieldably engages the ground point, the second conductive surface engaging a first end of the conductive element and the yieldable contact engaging a second end of the conductive element, conductively connected to the second conductive surface.

12. The electrical grounding structure according to claim 1, further comprising a substantially non-conductive support structure, the second conductive surface being attached to the substantially non-conductive support structure and the substantially non-conductive support structure engaging the first conductive surface so as to maintain a pre-defined separation between the first conductive surface and the second conductive surface.

13. The electrical grounding structure according to claim 12, further comprising a conductive element that forms at least part of a conductive path conductively coupling the second conductive surface to the ground point, the conductive element having an inductance that operates in conjunction with the pre-determined capacitance to exhibit a pre-defined impedance between the ground point and the first conductive surface near at least one RF frequency.

14. The electrical grounding structure according to claim 13, further comprising a yieldable contact that engages the conductive element at a second end, the yieldable contact yieldably engages the RF ground point.

15. The electrical grounding structure according to claim 14, wherein the second conductive surface, conductive element and yieldable contact form a yieldable clip that is formed from a yieldable, conductive material, the yieldable clip adapted to attach to the substantially non-conductive surface.

16. A wireless communications section that provides an RF ground to an enclosure, the wireless communications section comprising:
at least one of a receiver that wirelessly receives transmitted signals and a transmitter that wirelessly transmits signals; and
an RF grounding structure, comprising:
a ground point;
a first conductive surface of a device enclosure, conductively isolated from the ground point; and
a second conductive surface, conductively coupled to the ground point and physically separated from the first conductive surface, positioned so as to capacitively couple to the first surface with a pre-determined capacitance within an RF band of interest.

17. The wireless communications section according to claim 16, further comprising at least one antenna coupled to the at least one receiver and transmitter.

18. A wireless device, comprising:
a device enclosure;
at least one of an receiver that wirelessly receives transmitted signals and a transmitter that wirelessly transmits signals;
a baseband processing portion, communicatively coupled to the at least one receiver and transmitter, that processes at least one of data, voice, image and video signals in order to interface with at least one of the receiver and the transmitter;
an RF grounding structure, comprising:
a ground point;
a first conductive surface of the device enclosure, conductively isolated from the ground point; and
a second conductive surface, conductively coupled to the ground point and physically separated from the first conductive surface, positioned so as to capacitively couple to the first surface with a pre-determined capacitance within an RF band of interest.
